(19) United States
(12) Patent Application Publication
(10) Pub. No.: US 2022/0155043 A1
(43) Pub. Date: May 19, 2022

(54) Auxiliary Battery Lock-Out for Holographic Weapon Sight

(71) Applicant: RDP Components, Roseville, CA (US)

(72) Inventor: Colin White, Roseville (CA)

(73) Assignee: RDP Components, Roseville, CA (US)

(21) Appl. No.: 17/527,086

(22) Filed: Nov. 15, 2021

Related U.S. Application Data
(60) Provisional application No. 63/114,376, filed on Nov. 16, 2020.

(51) Int. Cl. F41G 1/30; F41G 1/34; H01M 50/247

(52) U.S. Cl. CPC F41G 1/30; F41G 11/003; H01M 50/247; F41G 1/345

(57) ABSTRACT

Power supply systems and methods for holographic weapon sights having a power switch that completely cuts off the power supply to eliminate parasitic power drain when an electro-optical sight is not in use to improve battery life.

The present application claims priority to U.S. Provisional Application No. 63/114,376, filed Nov. 16, 2020.

### TECHNICAL FIELD

The present disclosure relates to power supply systems and methods for holographic weapon sights. In particular, a switch completely cuts off the power supply to eliminate parasitic power drain when not in use to improve battery life.

### BACKGROUND OF THE INVENTION

Optic or holographic sights are known. For example, US20180292168A1, incorporated herein by reference, discloses an optic or holographic sight for a weapon that includes an electro-optical sight unit configured to project a reticle image for a sight setting of the optic sight apparatus. As shown in FIG. 1, the optic or holographic sight is powered by a battery (not shown) stored in a battery storage compartment 10. A threaded cap 12 closes the battery storage compartment 10 and provides one of the electrical contacts with the battery. The battery may be a CR123 battery. The optic or holographic sight illustrated in US20180292168A1 is sold by EOTech and is identified as Models XPS and EXPS.

As another example, U.S. Pat. No. 6,490,060B1, incorporated herein by reference, discloses a lightweight contact holographic sight that includes a housing and a base which form a compartment containing a laser diode, an associated power source, and optical elements including a mirror, an off axis collimator, a reflection grating, and an image hologram of a reticle pattern, wherein the optical elements are arranged within the compartment to direct and fold the laser beam in a substantially generally vertical path. As shown in FIGS. 2A-2C, the optic or holographic sight has a removable battery compartment 10 including a cam surface which is releasably contacted by a cam lever arm pivotally mounted on the sight housing or the base to allow for quick tool-less removal of the compartment for battery replacement. The optic or holographic sight illustrated in U.S. Pat. No. 6,490,060B1 is sold by EOTech and is identified as Model 551.

### BRIEF SUMMARY OF THE INVENTION

The present disclosure relates to power supply systems and methods for holographic weapon sights, wherein a switch completely cuts off the power supply to eliminate parasitic power drain when not in use to improve battery life.

According to one aspect of the invention, there is provided a sight apparatus comprising: a housing; an electro-optical sight unit supported by the housing and comprising an electro-optical sight and a control circuit, wherein the control circuit provides power and control signals to the electro-optical sight, an control switch in electrical communication with the control circuit; a battery compartment for supporting at least one battery, wherein the batter compartment is in mechanical communication with the housing; a power supply circuit in electrical communication between the battery compartment and the control circuit to supply power from a battery in the battery compartment to the control circuit; a power switch in the power supply circuit, wherein when the power switch is closed it allows power to be supplied from the battery to the control circuit, and wherein when the power switch is open it disallows power to be drained from the battery.

A further aspect of the invention provides an auxiliary lock for a sight apparatus comprising: an auxiliary housing engageable with a sight housing; a power supply circuit associated with the auxiliary housing in electrical communication between a sight battery and a sight control circuit; an auxiliary power switch in the power supply circuit, wherein when the auxiliary power switch is closed it allows power to be supplied from the optic sight battery to the optic sight control circuit, and wherein when the auxiliary power switch is open it disallows power to be drained from the optic sight battery.

According to another aspect of the invention, there is provided a method for supplying power to a sight apparatus, the method comprising: providing a power supply circuit in electrical communication between an optical sight battery and an optical sight control circuit; providing an auxiliary power switch in the power supply circuit, wherein when the auxiliary power switch is closed power is supplied from the battery to the optical sight control circuit, and wherein when the auxiliary power switch is open power cannot be drained from the battery.

### BRIEF DESCRIPTION OF THE DRAWINGS

A more complete understanding of the present embodiments may be acquired by referring to the following description taken in conjunction with the accompanying drawings, in which like reference numbers indicate like features.

FIG. 1 is a perspective view of a prior art optic sight apparatus.

FIG. 2A is a perspective view of a prior art optic sight apparatus having a removable battery compartment.

FIG. 2B is a side view of the prior art optic sight apparatus shown in FIG. 2A, wherein the battery compartment is detached from the housing.

FIG. 2C is a side view of the prior art optic sight apparatus shown in FIG. 2A, wherein the battery compartment is attached to the housing.

FIG. 3 is a photograph of an optic sight apparatus of the present invention having a cap/switch assembly closing the battery compartment, and further illustrating a prior art cap, a switch and a cap of the present invention.

FIG. 4 is a side view of an optic sight apparatus of the present invention having an power switch incorporated into a detachable battery compartment.

FIG. 5 is a circuit diagram of an embodiment of the invention having a power switch.

FIG. 6A is an isometric view of a cap or auxiliary housing.

FIG. 6B is a front view of the cap or auxiliary housing shown in FIG. 6A.

FIG. 6C is a side view of the cap or auxiliary housing shown in FIGS. 6A and 6B.

### DETAILED DESCRIPTION OF THE INVENTION

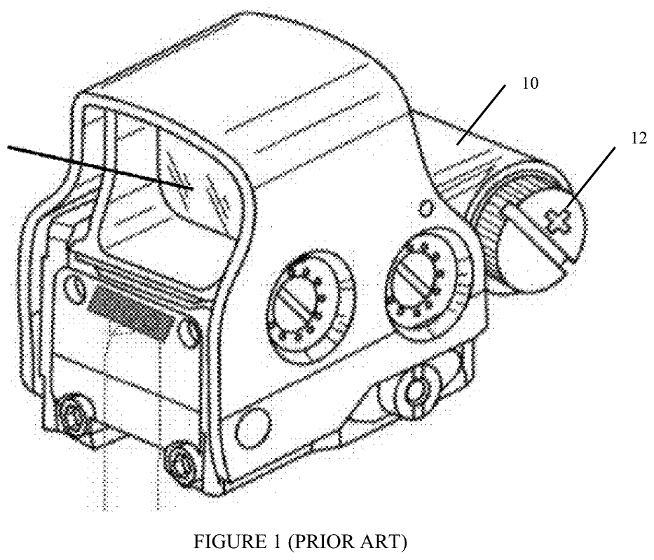

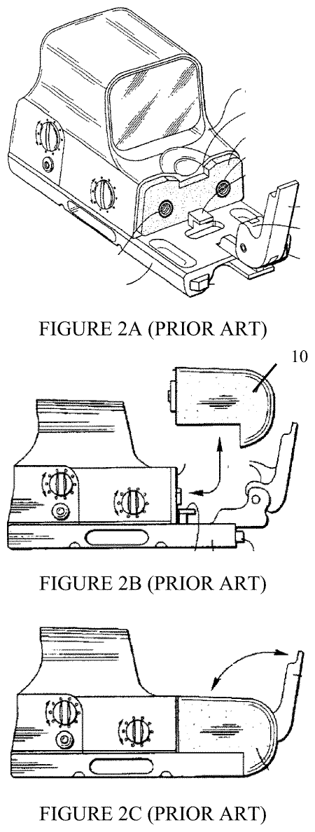

Preferred embodiments are best understood by reference to FIGS. 1-5 below in view of the following general discussion. The present disclosure may be more easily understood in the context of a high-level description of certain embodiments. Specific details are given in the following description to provide a thorough understanding of the embodiments. However, it will be understood by one of ordinary skill in the art that embodiments may be practiced without these specific details. For example, well-known circuits, processes, algorithms, structures, and techniques may be shown without unnecessary detail in order to avoid obscuring the embodiments.

The present disclosure relates to power supply systems and methods for sights, wherein a switch completely cuts off the power supply to eliminate parasitic power drain when not in use to improve battery life. The present invention is applicable to any and all battery powered sights and/or optics used in conjunction with any and all weapons, firearm, and guns, including for example center-fired firearms. In particular, as used herein the term “sight” means all battery operated optics and devices used for viewing distant objects or aiming (target acquisition) firearms such as any/all center fired firearms and other weapons (bow & arrow, crossbox, blow dart, etc.), including all types of sights such as reflex, holographic, prism, LED, laser red dots, etc.

The device (invention) provides the ability to disconnect (completely isolate) the power supply from the battery powered holographic sight quickly and easily. The purpose is to eliminate ALL parasitic drain from the power supply during storage/transport/non-use.

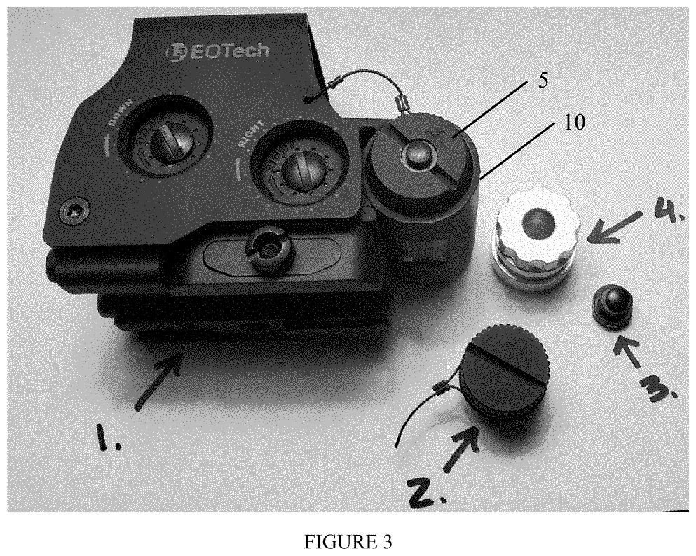

As shown in FIG. 3, an optic or holographic sight 1 has a battery compartment 10. A prior art threaded cap 2 is replaced with a cap or auxiliary housing 4 of the present invention. The cap or auxiliary housing 4 is threaded or otherwise configured to mate with the housing of the battery compartment 10, so that the cap or auxiliary housing 4 is in electrical communication when the cap or auxiliary housing 4 is secured with the battery compartment 10. Further, the cap or auxiliary housing 4 is mechanically enabled to receive a switch 3 and the switch 3 is electrically enabled to break the power circuit of the battery supply. A fully assembled cap/switch 5 is shown assembled with the battery compartment 10.

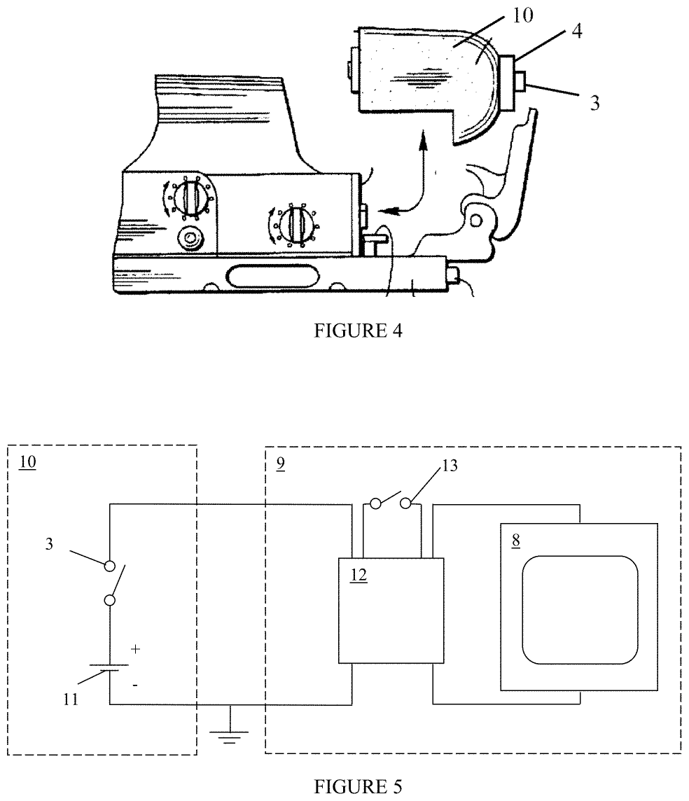

As shown in FIG. 4, one embodiment of the invention comprises an optic or holographic sight having a removable battery compartment 10. The cap or auxiliary housing 4 may be threaded or otherwise configured to mate with the removable battery compartment 10, so that the cap or auxiliary housing 4 is in electrical communication when the cap or auxiliary housing 4 is secured with the battery compartment 10. Further, the cap or auxiliary housing 4 is mechanically enabled to receive a switch 3 and the switch 3 is electrically enabled to break the power circuit of the battery supply.

FIG. 5 shows a circuit diagram. A batter 11 and power switch 3 are associated with a battery compartment 10. A control circuit 12 and electro-optical sight 8 are associated with a housing 9. The control circuit 12 is in electrical communication with the electro-optical sight 8 to provide both power and control. A control switch 13 is in electrical communication with the control circuit 12. The control switch 13 may appear to be an ON/OFF switch, but in reality it switches the control circuit 12 between active and sleep modes. In the active mode, the electro-optical sight 8 is powered ON and sight controls are fully functional. In the sleep mode, the electro-optical sight 8 is powered OFF and sight controls are inoperable. However, in the sleep mode, the control circuit 12 continues to consume power to maintain certain functions, such as clock, memory, etc. The power switch 3 determines whether power is supplied to the control circuit 12. When the power switch 3 is closed, it supplies power to the control circuit 12, and when the power switch 3 is open, it completely cuts off the power supply to eliminate parasitic power drain when the electro-optical sight 8 is not in use to improve battery life. The control circuit 12 may be implemented by analog circuitry, digital circuitry, instructions for execution by a processor (not shown), or any suitable combination thereof.

The power switch 3 connects and disconnects the power source or battery 11 from the electrical control circuit 12 used to power/provide/create the laser/LED reticle of the electro-optical sight 8 used to target the weapon.

One aspect of the invention adds an additional switch (power switch 3) to the power circuit of the gunsight to allow/provide a complete mechanical disconnect within the power circuit of the holographic/laser/LED optic sight.

According to one embodiment of the invention, a cover of the battery housing 9 contains a “push button” power switch 3 to completely isolate the power supply from the control circuit 12. According to different aspects of the invention, any secondary switching device that interrupts and/or isolates the power source (within a battery operated/powered optic) from the control circuit 12 may be used. Further aspects of the invention may use any means of which creates the adaptation/provision for a secondary/auxiliary power switch 3. Still other aspects of the invention may use any provision that adapts a switching device and/or system for interrupting the power to the control circuit 12. A power supply circuit may include any power switch 3 (momentary/non-moment/twist/twist & lock/double click/button to switch in any configuration and/or a push button switch). The power switch 3 may be integrated into the circuit and sight housing by any method of attachment (mounting/affixing/adapting of the switch to/in the housing or firearm); bolted, screwed, welded, casted, drilled, milled, threaded, glued, pressed, epoxied, 3D printed, extruded, piened, swadged, crimped, riveted, magnetized, clamped, or clipped. The power switch 3 may be a mechanical switch incorporated into the battery compartment 10.

In one illustrative embodiment of the invention, the battery compartment 10 is modified to retain the battery 11 or batteries (CR123) via a watertight seal with the aid of an O-ring. Provision for a lanyard retaining the cap/switch assembly 5 to the optic housing/frame/chassis 9 may be provided.

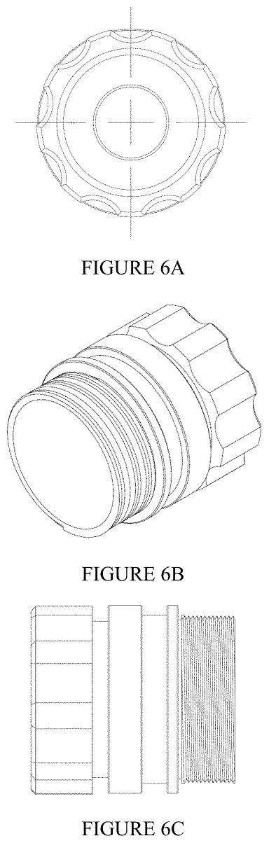

FIGS. 6A-6C illustrate a cap or auxiliary housing that provides the housing for an auxiliary switch. FIG. 6A is an isometric view. FIG. 6B is a front view of the cap or auxiliary housing. FIG. 6C is a side view of the cap or auxiliary housing illustrating the threads for engagement or threading into the threads of the battery chamber of the optic sight.

Although the disclosed embodiments are described in detail in the present disclosure, it should be understood that various changes, substitutions and alterations can be made to the embodiments without departing from their spirit and scope.

1. A sight apparatus comprising:
a housing;
an electro-optical sight unit supported by the housing and comprising an electro-optical sight and a control circuit, wherein the control circuit provides power and control signals to the electro-optical sight,
an control switch in electrical communication with the control circuit;
a battery compartment for supporting at least one battery, wherein the batter compartment is in mechanical communication with the housing;
a power supply circuit in electrical communication between the battery compartment and the control circuit to supply power from a battery in the battery compartment to the control circuit;
a power switch in the power supply circuit, wherein when the power switch is closed it allows power to be supplied from the battery to the control circuit, and wherein when the power switch is open it disallows power to be drained from the battery.

2. A sight apparatus as claimed in claim 1, wherein the battery compartment is part of the housing.

3. A sight apparatus as claimed in claim 1, wherein the battery compartment is attachable and detachable to and from the housing.

4. A sight apparatus as claimed in claim 1, wherein the power switch is attached to the battery compartment.

5. A sight apparatus as claimed in claim 1, wherein the power switch comprises a mechanical switch.

6. A sight apparatus as claimed in claim 1, wherein the power switch is a switch selected from momentary, non-moment, twist, twist and lock, double click, and button.

7. A sight apparatus as claimed in claim 1, wherein the power switch is incorporated into a cap of the battery compartment.

8. A sight apparatus as claimed in claim 1, wherein the housing is configured to be mountable to a firearm.

9. An auxiliary lock for a sight apparatus comprising:
an auxiliary housing engageable with a sight housing;
a power supply circuit associated with the auxiliary housing in electrical communication between a sight battery and a sight control circuit; an auxiliary power switch in the power supply circuit, wherein when the auxiliary power switch is closed it allows power to be supplied from the optic sight battery to the optic sight control circuit, and wherein when the auxiliary power switch is open it disallows power to be drained from the optic sight battery.

10. An auxiliary lock as claimed in claim 9, wherein the auxiliary housing engages with a battery compartment of the optic sight housing.

11. An auxiliary lock as claimed in claim 9 wherein the auxiliary housing in a cap having male threads threadable into female threads of a battery compartment of the optic sight housing, and wherein the auxiliary power switch is accessible on an exterior of the cap.

12. An auxiliary lock as claimed in claim 9, wherein the auxiliary power switch is in electrical contact with the optic sight battery.

13. An auxiliary lock as claimed in claim 9, wherein the power switch comprises a mechanical switch.

14. An auxiliary lock as claimed in claim 9, wherein the auxiliary power switch is a switch selected from momentary, non-moment, twist, twist and lock, double click, and button.

15. An auxiliary lock as claimed in claim 9, wherein the auxiliary housing is a replacement cap for a standard cap of a battery compartment of the optic sight housing.

16. A method for supplying power to a sight apparatus, the method comprising:
providing a power supply circuit in electrical communication between a sight battery and a sight control circuit;
providing an auxiliary power switch in the power supply circuit, wherein when the auxiliary power switch is closed power is supplied from the battery to the sight control circuit, and wherein when the auxiliary power switch is open power cannot be drained from the battery.

17. A method for supplying power to a sight apparatus, as claimed in claim 16, wherein said providing an auxiliary power switch comprises providing a mechanical switch.

18. A method for supplying power to a sight apparatus, as claimed in claim 16, wherein said providing an auxiliary power switch comprises providing a switch selected from momentary, non-moment, twist, twist and lock, double click, and button.
